(19) United States
(12) Patent Application Publication
(10) Pub. No.: US 2020/0310464 A1
(43) Pub. Date: Oct. 1, 2020

(54) OPERATION MANAGEMENT SYSTEM

(71) Applicant: TOYOTA JIDOSHA KABUSHIKI KAISHA, Toyota-shi (JP)

(72) Inventors: Hiroaki TAKAHASHI, Tokyo (JP); Yohei TANIGAWA, Toyota-shi (JP); Junichi GOTO, Toyota-shi (JP); Yoshihisa SUGANO, Tokyo (JP); Tomoyuki TANAKA, Tokyo (JP); Kosuke KATOU, Tokyo (JP); Tokihiro MOTOYAMA, Tokyo (JP)

(73) Assignee: TOYOTA JIDOSHA KABUSHIKI KAISHA, Toyota-shi (JP)

(21) Appl. No.: 16/835,867

(22) Filed: Mar. 31, 2020

(30) Foreign Application Priority Data
Apr. 1, 2019 (JP) 2019-069753

(51) Int. Cl. G05D 1/02; G06Q 50/30; G06Q 10/08; G06Q 10/06

(52) U.S. Cl. CPC G05D 1/0297; G06Q 50/30; G05D 2201/0212; G06Q 10/06315; G06Q 10/083

(57) ABSTRACT

An operation management system manages the operation of a transport vehicle that transports a freight W from a first cross dock to a second cross dock. The operation management system includes a freight information acquisition unit that acquires freight information including a delivery destination of the freight for each freight, a number determination unit that determines the required number of transport vehicles for transporting the freight from the first cross dock to the second cross dock based on the freight information acquired by the freight information acquisition unit, and an output unit that outputs information regarding the required number determined by the number determination unit.

### CROSS-REFERENCE TO RELATED APPLICATION

This application claims the benefit of priority from Japanese Patent Application No. 2019-069753, filed on Apr. 1, 2019, the entire contents of which are incorporated herein by reference.

### TECHNICAL FIELD

The present disclosure relates to an operation management system that manages the operation of a transport vehicle that transports freights.

### BACKGROUND

For example, Japanese Unexamined Patent Publication No. 2001-261123 discloses an apparatus that generates an operation plan of a vehicle that delivers freights collected at a collection and delivery location to each destination. Such an apparatus generates a delivery route that sequentially goes through delivery destinations of the freights in order to efficiently deliver the freights.

### SUMMARY

Here, there is a transport vehicle that transports freights between cross docks in which freight are collected. Regarding such a transport vehicle that transports a freight between two locations, efficient transportation of freight is also required.

Thus, an object of the present disclosure is to provide an operation management system capable of efficiently transporting a freight from a first location to a second location.

According to the present disclosure, an operation management system that manages the operation of a transport vehicle that transports freight from a first location to a second location includes a freight information acquisition unit that acquires freight information including a delivery destination of the freight for each freight, a number determination unit that determines the required number of transport vehicles for transporting the freight from the first location to the second location based on the freight information acquired by the freight information acquisition unit, and an output unit that outputs information regarding the required number determined by the number determination unit.

In the operation management system, it is possible to determine the required number of transport vehicles for transporting the freight from the first location to the second location based on the freight information. As described above, since the required number of transport vehicles required for transportation is determined, for example, there is no need to keep an excessive number of transport vehicles on standby. Thus, in the operation management system, it is possible to efficiently transport the freight from the first location to the second location.

In the operation management system, the transport vehicle may depart from the first location at each departure time defined in a preset operation plan of the transport vehicle. The number determination unit may determine the required number for each departure time, based on the freight information. In this case, in the operation management system, it is possible to determine the required number of vehicles for each departure time even in a case where the transport vehicle departs from the first location in accordance with the predetermined operation plan.

In the operation management system, the transport vehicle may transport the freight by being guided or towed by the guidance vehicle in at least one of sections from the first location to the second location. In this case, the transport vehicle can transport the freight by being guided or towed by the guidance vehicle.

The operation management system may further include a guidance vehicle determination unit that determines the guidance vehicle. The guidance vehicle determination unit determines one or a plurality of transport vehicles as the guidance vehicle, based on the required number determined by the number determination unit and a predetermined guidable number of vehicles allowed to be guided by the guidance vehicle. The output unit may further output information of the transport vehicles determined as the guidance vehicle. In this case, in the operation management system, it is possible to determine one or a plurality of transport vehicles as the guidance vehicle in consideration of the guidable number of vehicles.

The operation management system may further include a guidance vehicle determination unit that determines the guidance vehicle, and an operation plan acquisition unit that acquires an operation plan of a regular operation vehicle. The guidance vehicle determination unit may determine any one or more of the transport vehicle and the regular operation vehicle as the guidance vehicle, based on the required number determined by the number determination unit, the predetermined guidable number of vehicles allowed to be guided by the guidance vehicle, and the operation plan of the regular operation vehicle. The output unit may output information of any one or more of the transport vehicle and the regular operation vehicle determined as the guidance vehicle. In this case, in the operation management system, it is possible to determine the regular operation vehicle as the guidance vehicle in consideration of the operation plan of the regular operation vehicle. That is, it is possible to utilize the regular operation vehicle as the guidance vehicle. Accordingly, it is possible to improve efficiency of transportation of a freight without a need to prepare a vehicle dedicated for guidance, as the guidance vehicle.

In the operation management system, the regular operation vehicle may be a bus capable of transporting a plurality of occupants. In the operation management system, the guidance vehicle may be a bus capable of transporting a plurality of occupants. In this case, it is possible to simultaneously transport occupants and freights by the bus as the guidance vehicle and the transport vehicle that transports the freights. Thus, it is possible to improve the efficiency of the entire physical distribution.

In the operation management system, the transport vehicle may be an autonomous driving vehicle capable of traveling autonomously, and autonomously travel following the guidance vehicle, by being guided by the guidance vehicle. In this case, a driver who drives the transport vehicle is not required, and the efficiency of transporting the freight can be further improved.

According to the present disclosure, it is possible to efficiently transport freights from the first location to the second location.

### BRIEF DESCRIPTION OF THE DRAWINGS

FIG. 1 is a schematic block diagram illustrating a configuration of an operation management system according to an embodiment.

FIG. 2 is a schematic diagram illustrating a flow of a freight in a cross dock.

FIG. 3 is a schematic diagram illustrating a relation between a transport route of a transport vehicle and a travel route of a bus.

FIG. 4 is a schematic diagram illustrating a line of transport vehicles.

FIG. 5 is a schematic diagram illustrating a line of the transport vehicles.

FIG. 6 is a plan view illustrating a scene in which the transport vehicle joins behind the bus while the bus is traveling.

FIG. 7 is a flowchart illustrating a flow of management processing performed by the operation management system.

### DETAILED DESCRIPTION

Hereinafter, an embodiment of the present disclosure will be described with reference to the drawings. In the following description, the same or corresponding elements will be denoted by the same reference signs, and repetitive description will be omitted.

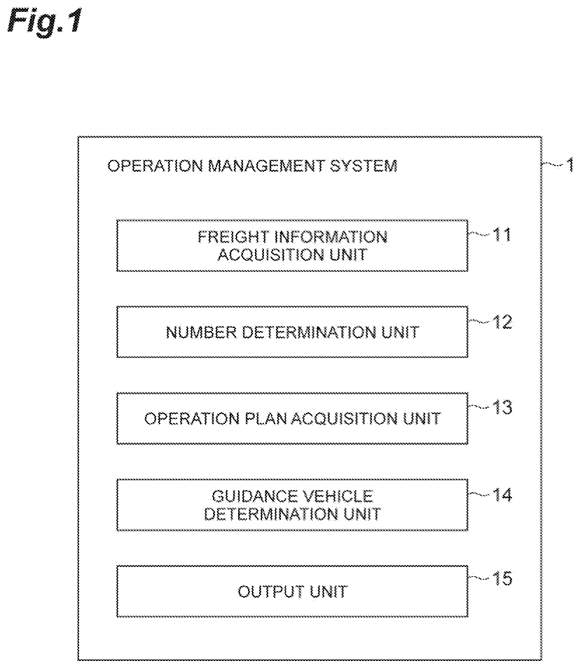

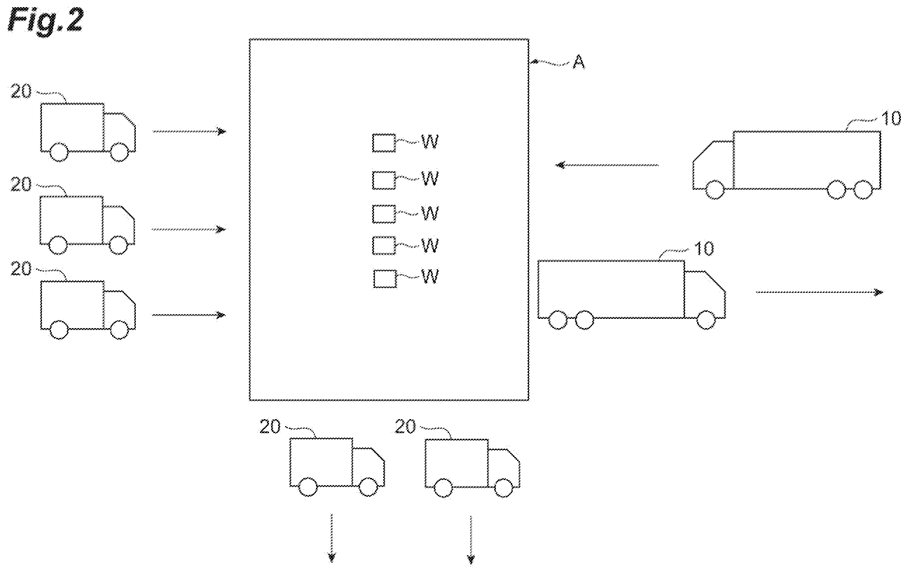

An operation management system 1 illustrated in FIG. 1 manages the operation of a transport vehicle 10 (see FIG. 2) that transports a freight. Here, as illustrated in FIG. 2, the transport vehicle 10 receives the freight W at a cross dock A as a source of the freight W, and transports the received freight W to the cross dock A as a destination. The cross dock A is a facility in which a plurality of freights W are collected, and serves as a relay location for transporting the freights W. For example, the cross dock A is provided at each of a plurality of locations. For example, the transport vehicle 10 may be a large vehicle capable of transporting a plurality of freights W between the cross docks A at a time.

For example, in the cross dock A, a plurality of freights W are collected by a plurality of collection and delivery vehicles 20. The freights W collected in the cross dock A are sorted for each cross dock A serving as a relay location, based on the delivery destinations of the freights W. The sorted freights W are loaded on the transport vehicle 10 and transported to the cross dock A as the destination. The freights W transported to the cross dock A by the transport vehicle 10 are loaded on the collection and delivery vehicles 20 and delivered to the respective delivery destinations.

The cross dock A is provided on the side of the main road or near the main road. The cross dock A may be provided near the entrance of the expressway or on the side of the expressway. Thus, the transport vehicle 10 can mainly travel on the wide road and/or the highway between the cross docks A, and can easily transport the freight W.

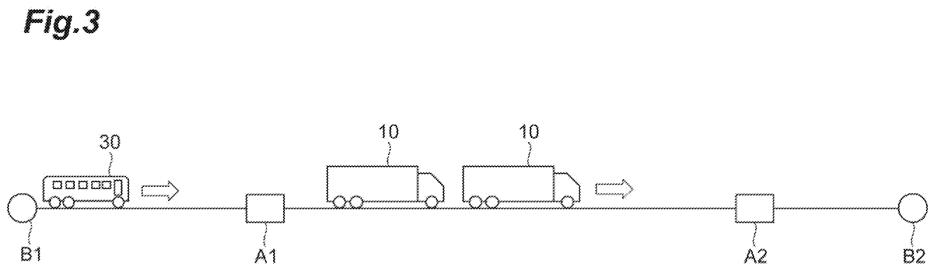

As illustrated in FIG. 3, management of an operation of the transport vehicle 10, which is performed by the operation management system 1 in a case where the transport vehicle 10 transports a freight W from a first cross dock (first location) A1 to a second cross dock (second location) A2 will be described below.

In the first cross dock A1, an operation plan of the transport vehicle 10 that transports the freight W to the second cross dock A2 is predetermined. In the operation plan, the departure time of the transport vehicle 10 that departs from the first cross dock A1 to the second cross dock A2 is defined. The transport vehicle 10 departs from the first cross dock A1 to the second cross dock A2 at every predetermined departure time in accordance with the operation plan.

The operation management system 1 manages the operation of the transport vehicle 10 to issue an instruction of the transport vehicle 10 used for transporting the freight W among the plurality of transport vehicles 10 and an instruction of the freight W to be loaded, for example.

In the present embodiment, the transport vehicle 10 is an autonomous driving vehicle capable of autonomously traveling. The transport vehicle 10 is not limited to performing only the autonomous driving, and may be capable of switching between manual driving of traveling by driving operation of a driver and autonomous driving.

In a case where a plurality of transport vehicles 10 depart toward the second cross dock A2 at the same departure time, the transport vehicles 10 form a line and travels toward the second cross dock A2. The maximum line number (for examples, three) being the maximum number of vehicles forming the line is predetermined. The transport vehicles 10 forming the line are travels in a row to be sequentially connected behind the leading vehicle. The maximum line number may be determined in consideration of the maximum number of vehicles allowed in a case where the transport vehicles 10 sequentially travel by autonomous driving.

The transport vehicles 10 form a line with a number equal to or less than the predetermined maximum line number, and travels toward the second cross dock A2 for each line. The transport vehicle 10 may travel in a line in only at least one of sections, not all the sections from the first cross dock A1 to the second cross dock A2.

In the present embodiment, in a case where the transport vehicles 10 travel in a line, one of the vehicles forming the line serves as a guidance vehicle for guiding the line. The transport vehicle 10 is determined as the guidance vehicle. A bus 30 described later may be determined as the guidance vehicle. The transport vehicles 10 other than the guidance vehicle, which form the line, are autonomously travels behind the guidance vehicle with sequentially following the guidance vehicle, while being guided by the guidance vehicle. That is, the transport vehicle 10 is guided by the guidance vehicle to autonomously travel following the guidance vehicle with a predetermined vehicle-to-vehicle distance. In addition, as a method in which the transport vehicle 10 travels following the guidance vehicle by autonomous driving, various known methods of causing a vehicle to travel to follow the preceding vehicle may be used.

The transport vehicles 10 other than the guidance vehicle, which form the line, may be guided by the guidance vehicle in at least one of sections, not all the sections from the first cross dock A1 to the second cross dock A2. For example, the transport vehicles 10 other than the guidance vehicle, which form the line, may be guided by the guidance vehicles when traveling on the highway. For example, the transport vehicle 10 other than the guidance vehicle, which forms the line, may travel by a driving operation of a driver until a location at which guidance by the guidance vehicle is started. After the transport vehicle 10 reaches the location at which the guidance is started, the transport vehicle may autonomously travel by autonomous driving while being guided by the guidance vehicle. For example, the transport vehicle 10 as the guidance vehicle may travel by the driving operation of the driver, and may autonomously travel by autonomous driving.

The operation management system 1 illustrated in FIG. 1 is an electronic control unit including a central processing unit (CPU), a read only memory (ROM), a random access memory (RAM), a communication device, and the like. The operation management system 1 controls hardware based on signals output by the CPU, and implements various functions described later. The operation management system 1 may be provided in the first cross dock A1, may be provided in a place other than the first cross dock A1, or may be partially provided in a place other than the first cross dock A1. For example, the operation management system 1 may be configured by a server.

Functionally, as illustrated in FIG. 1, the operation management system 1 includes a freight information acquisition unit 11, a number determination unit 12, an operation plan acquisition unit 13, a guidance vehicle determination unit 14, and an output unit 15.

The freight information acquisition unit 11 acquires freight information for each freight W collected in the first cross dock A1 by the collection and delivery vehicle 20. This freight information includes information of the delivery destination of the freight W. The freight information may include information of the size, the weight, and the like of the freight W. The freight information acquisition unit 11 acquires the freight information by various known methods. For example, the freight information acquisition unit 11 may acquire the freight information based on an input operation of an operator. For example, the freight information acquisition unit 11 may acquire the freight information by reading a barcode or the like attached to the freight W. For example, the freight information acquisition unit 11 may acquire the freight information input by an operator or the like via a communication line.

The number determination unit 12 determines the required number of transport vehicles 10 for transporting the freight from the first cross dock A1 to the second cross dock A2, based on the freight information acquired by the freight information acquisition unit 11. Here, for example, the number determination unit 12 determines the required number of transport vehicles 10 to be used for transporting the freight W at the next departure time, based on the freight information of the freight W to be transported at the next departure time. That is, the number determination unit 12 determines the required number for each departure time included in the operation plan. The number determination unit 12 determines the transport vehicles 10 to be used for the current transportation, based on the determined required number.

For example, the number determination unit 12 determines whether or not the freight W is to be delivered to the second cross dock A2, based on delivery destination information included in the freight information. For example, the number determination unit 12 may determine the required number based on the number of freights W to be transported to the second cross dock A2. For example, the number determination unit 12 may determine the required number based on the size, the weight, and the like of the freight W, which are included in the freight information. The number determination unit 12 stores information of the size of a freight compartment of the transport vehicle 10, a loadable weight, and the like, in advance. The number determination unit 12 may determine the required number based on the information of the freight compartment and the like.

The operation plan acquisition unit 13 acquires an operation plan of a regular operation vehicle. The regular operation vehicle is a vehicle other than the transport vehicle 10, and is a vehicle that travels regularly in accordance with a predetermined operation plan. The operation plan acquisition unit 13 may acquire the operation plan of the regular operation vehicle, for example, from a server that manages the regular operation vehicle. The operation plan acquisition unit 13 may acquire the operation plan of the regular operation vehicle by being input by an operator. The operation plan acquisition unit 13 acquires the operation plan at a predetermined timing and stores the acquired operation plan. For example, in a case where the operation plan of the regular operation vehicle is changed, the operation plan acquisition unit 13 may acquire a new operation plan.

In the present embodiment, as illustrated in FIG. 3, the regular operation vehicle is set to be a bus 30 capable of transporting a plurality of occupants. The operation plan of the bus 30 includes a departure time of a departure place B1 and/or a passing time of each location through which the bus 30 passes. The bus 30 may be, for example, an occupant transport vehicle that transports occupants between cities.

Here, the operation plan acquisition unit 13 acquires the operation plan of the bus 30, which allows the bus to pass through the first cross dock A1 and the second cross dock A2, in a case where the bus 30 travels from the departure place B to the destination B2. The operation plan acquisition unit 13 may acquire the operation plan of the bus 30, which allows the bus to pass through the vicinity of the first cross dock A1 and the vicinity of the departure place B1. In addition, the operation plan acquisition unit 13 may acquire the operation plan of the bus 30, which allows the bus to pass through at least a section in a route on which the transport vehicle 10 travels from the first cross dock A1 to the second cross dock A2.

The guidance vehicle determination unit 14 determines a line of the transport vehicles 10 and a guidance vehicle that guides the line. Specifically, the guidance vehicle determination unit 14 determines one or a plurality of transport vehicles 10 as the guidance vehicle, based on the required number determined by the number determination unit 12 and a predetermined guidable number. The guidable number is the maximum number of the transport vehicles 10 allowed to be guided by the guidance vehicle. That is, the guidable number is the maximum number of transport vehicles 10 which can follow behind the guidance vehicle by autonomous driving. In the present embodiment, the maximum line number is set to a number obtained by adding 1 to the guidable number.

Here, firstly, the guidance vehicle determination unit 14 determines the line by grouping the transport vehicles 10 used for transporting the freight W so as not to exceed the maximum line number. The guidance vehicle determination unit 14 determines one transport vehicle 10 of a plurality of transport vehicles 10 in each line, as the guidance vehicle.

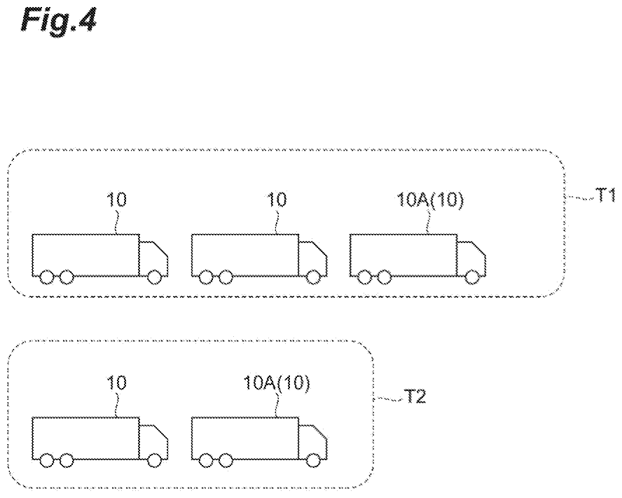

As described above, the guidance vehicle determination unit 14 determines one guidance vehicle from the transport vehicles 10 forming a line, for each line. For example, as illustrated in FIG. 4, in a case where the maximum line number of the vehicles is three (in a case where the guidable number of vehicles is two), the guidance vehicle determination unit 14 determines one transport vehicle 10 of the three transport vehicles 10, as a guidance vehicle 10A. FIG. 4 illustrates a case where the required number of vehicles determined based on the freight information is five, and a line T1 and a line T2 are formed. The guidance vehicle 10A travels, for example, at the head of the line and guides other transport vehicles 10 in the line. The guidance vehicle 10A may guide the other transport vehicles 10 from the departure time of the first cross dock A1, or may guide the other transport vehicles 10 in at least one of sections from the first cross dock A1 to the second cross dock A2.

The guidance vehicle determination unit 14 may determine the bus 30 as the guidance vehicle. Specifically, the guidance vehicle determination unit 14 determines any one or more of the transport vehicles 10 and the bus 30 as the guidance vehicle, based on the required number determined by the number determination unit 12, the predetermined guidable number, and the operation plan of the bus 30 acquired by the operation plan acquisition unit 13. In the present embodiment, in a case where using the bus 30 as the guidance vehicle is allowed, the guidance vehicle determination unit 14 determines the bus 30 as the guidance vehicle.

Here, firstly, the guidance vehicle determination unit 14 determines whether or not the bus 30 may serve as the guidance vehicle, based on the operation plan of the bus 30. For example, in a case where it is predicted that the bus 30 is capable of arriving at the first cross dock A1 at a predetermined departure time of the transport vehicle 10, the guidance vehicle determination unit 14 determines that the bus 30 may serve as the guidance vehicle. That is, this case means a case where the bus 30 is allowed to guide the other transport vehicles 10 from the departure time of the first cross dock A1.

For example, in a case where it is predicted that the bus 30 is allowed to join with the transport vehicles 10 in the middle of a route toward the second cross dock A2 when the transport vehicle 10 departs at a predetermined departure time, the guidance vehicle determination unit 14 determines that the bus 30 may serve as the guidance vehicle. That is, this case means a case where the bus 30 is allowed to guide the other transport vehicles 10 in at least one of sections from the first cross dock A1 to the second cross dock A2.

In a case where the guidance vehicle determination unit determines that the bus 30 may serve as the guidance vehicle, the guidance vehicle determination unit 14 adds the bus 30 to the grouping target of the line for transporting the freights W. The guidance vehicle determination unit 14 determines the line by grouping the bus 30 and the transport vehicles 10 used for transporting the freight W so as not to exceed the maximum line number. Further, the guidance vehicle determination unit 14 determines one transport vehicle 10 of a plurality of transport vehicles 10 in each line, as the guidance vehicle. In a case where the bus 30 is included in the line, the guidance vehicle determination unit 14 determines the bus 30 as the guidance vehicle.

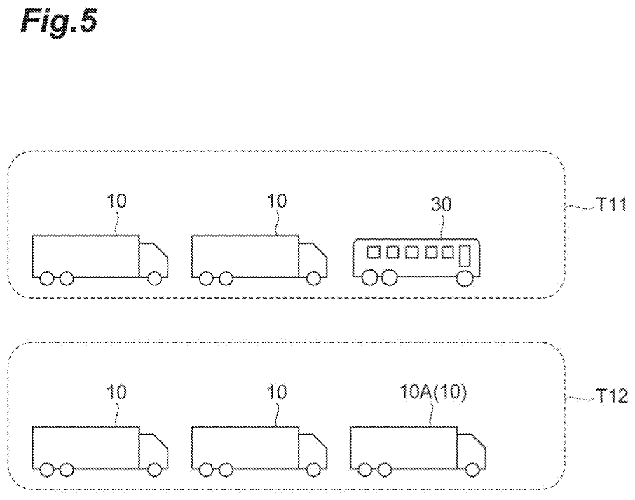

As described above, as illustrated in FIG. 5, in a case where the maximum line number of vehicles is three, the guidance vehicle determination unit 14 determines the bus 30 as the guidance vehicle for a line T11 including the bus 30. The guidance vehicle determination unit 14 determines one transport vehicle 10 of the transport vehicles 10 forming the line, as the guidance vehicle 10A for a line T12 that does not include the bus 30. FIG. 5 illustrates a case where the required number of vehicles determined based on the freight information is five, and the line T11 including the bus 30 and the line T12 which does not include the bus 30 are formed. In the line T11, the bus 30 as the guidance vehicle travels, for example, at the head of the line T11 and guides the remaining two transport vehicles 10. In the line T12, the guidance vehicle 10A travels, for example, at the head of the line T12 and guides the remaining two transport vehicles 10.

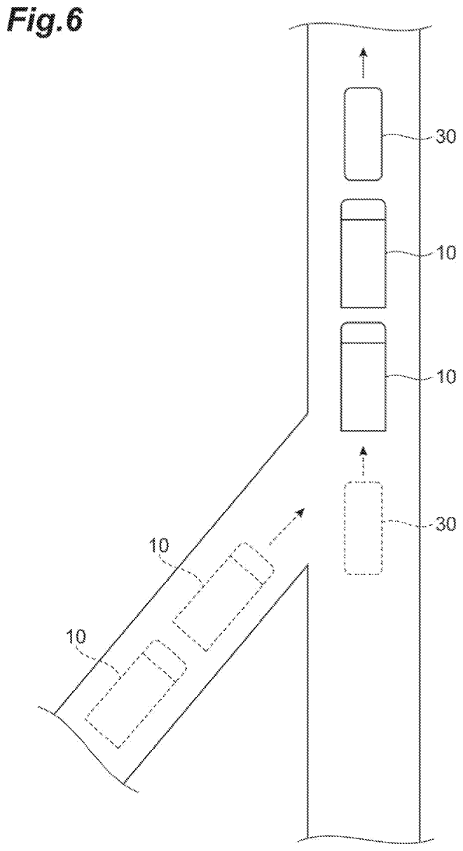

In a case where the bus 30 as the guidance vehicle passes through the first cross dock A1 and the second cross dock A2, the bus 30 may guide other transport vehicles 10 during a period from the departure time of the first cross dock A1 until the bus arrives at the second cross dock A2. The bus 30 as the guidance vehicle may guide other transport vehicles 10 in at least one of sections from the first cross dock A1 to the second cross dock A2. In this case, for example, as illustrated in FIG. 6, the transport vehicle 10 guided by the bus 30 may join behind the bus 30 in the process of the bus 30 traveling, and may be sequentially guided by the bus 30. Thus, it is not necessary that the bus 30 stops to guide the transport vehicle 10. In this case, the transport vehicle 10 guided by the bus 30 may travel toward the second cross dock A2 until the transport vehicle 10 joins with the bus 30. Alternatively, in a case of the transport vehicles 10 to be guided by the bus 30, one of the transport vehicles 10 may serve as the guidance vehicle and guide other transport vehicles 10 until the transport vehicles 10 join with the bus 30.

In a case where the transport vehicle 10 does not reach the second cross dock A2 after the guidance by the bus 30 is completed, the transport vehicle 10 may travel toward the second cross dock A2. Alternatively, the transport vehicles 10 may travel to the second cross dock A2 in a manner that one of the transport vehicle 10 serves as the guidance vehicle and guides other transport vehicles 10. The bus 30 transports occupants to the destination B2 after the guidance of the transport vehicle 10 is completed.

As illustrated in FIG. 1, the output unit 15 outputs operation management information. The operation management information refers to information for managing the operation of the transport vehicle 10. The transport vehicle 10 receives the freight W based on the operation management information, and transports the received freight W. The output unit 15 may transmit the operation management information to the transport vehicle 10 by wireless communication or the like, as a manner of outputting the operation management information. In a case where the bus 30 is determined as the guidance vehicle, the output unit 15 may transmit the operation management information to the bus 30 by wireless communication or the like, as a manner of outputting the operation management information.

The operation management information includes information regarding the required number of vehicles determined by the number determination unit 12. The information regarding the required number refers to information for allowing specifying of the determined required number. For example, the information regarding the required number may refer to the value (the number) itself of the required number or refer to another kind of information allowing specifying of the required number. For example, another kind of information allowing specifying of the required number may refer to vehicle identification information for identifying the transport vehicle 10 used for the current transportation. The number of transport vehicles 10 identified by the vehicle identification information may be the required number.

The operation management information may include information of any one or more of the transport vehicle 10 and the bus 30 determined as the guidance vehicle. The information of the transport vehicle 10 determined as the guidance vehicle may include vehicle identification information for identifying the transport vehicle 10 as the guidance vehicle. Similarly, the information of the bus 30 determined as the guidance vehicle may include vehicle identification information for identifying the bus 30 as the guidance vehicle. The operation management information includes line information indicating transport vehicles 10 which form a line.

The output unit 15 may transmit the operation management information to a display control unit that controls a display device provided in the first cross dock A1 or the like, as a manner of outputting the operation management information. The display control unit which has received the information from the output unit 15 may cause the display device to display the received information. In this case, a worker or the like in the first cross dock A1 can perform a work of transporting the freight W and the like by checking the display contents of the display device. The output unit 15 may open the operation management information to the public to be allowed to be viewed on the Internet, as a manner of outputting the operation management information. The output unit 15 may output the operation management information to a printing device or the like that performs printing of text information and the like on paper, as a manner of outputting the operation management information. The printing device which has received the information from the output unit 15 performs printing of the received information on paper. In this case, a worker or the like in the first cross dock A1 can perform a work of transporting the freight W and the like by checking information printed on the paper.

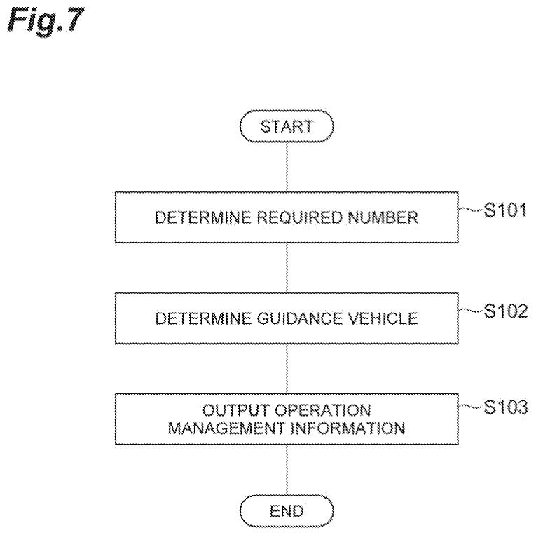

Next, an example of a flow of operation management processing of the transport vehicle 10, which is performed by the operation management system 1 in a case where the transport vehicle 10 transports the freight W from the first cross dock A1 to the second cross dock A2 will be described. The management processing illustrated in FIG. 7 may be performed, for example, when a departure time defined in an operation plan for transporting the freight W nears, or the management processing may be performed at another timing.

The number determination unit 12 determines the required number of transport vehicles 10 for transporting the freight from the first cross dock A1 to the second cross dock A2, based on the freight information acquired by the freight information acquisition unit 11 (S101). The freight information acquisition unit 11 normally acquires and stores freight information and the like input by an operator. The number determination unit 12 may determine the required number using the freight information stored by the freight information acquisition unit 11. The guidance vehicle determination unit 14 determines formation of a line and the guidance vehicle based on the determined required number of vehicles and the like (S102). The output unit 15 outputs operation management information obtained based on the determination result and the like of the number determination unit 12 (S103).

Thus, for each departure time, the number of transport vehicles 10 required for transporting the freight W are collected in the first cross dock A1, and the freight W is loaded on the transport vehicle 10. The transport vehicle 10 forms a line based on operation management information, and transports the freight W to the second cross dock A2. When forming a line and transporting the freight W, the transport vehicle 10 autonomously travels following the guidance vehicle while being guided by the guidance vehicle. If the vehicle arrives at the second cross dock A2, the freight W is unloaded from the transport vehicle 10 to the second cross dock A2.

As described above, in the operation management system 1, it is possible to determine the required number of transport vehicles 10 for transporting the freight W from the first cross dock A1 to the second cross dock A2, based on the freight information. As described above, since the required number of transport vehicles 10 required for transportation is determined, for example, there is no need to keep an excessive number of transport vehicles 10 on standby. Thus, in the operation management system 1, it is possible to efficiently transport the freight W between the cross docks A.

The transport vehicle 10 departs from the first cross dock A1 at each departure time defined in an operation plan of the transport vehicle 10 set in advance, and transports the freight W to the second cross dock A2. Therefore, in the operation management system 1, the required number of vehicles for each departure time is determined based on the freight information. Thus, in the operation management system 1, it is possible to determine the required number of vehicles at each departure time required for transporting the freight W even in a case where the transport vehicle 10 departs from the first cross dock A1 in accordance with a predetermined operation plan.

The transport vehicle 10 transports the freight W in a manner that the transport vehicle 10 autonomously travels following the guidance vehicle while being guided by the guidance vehicle in at least one of sections from the first cross dock A1 to the second cross dock A2. In this case, the transport vehicle 10 can transport the freight W by being guided by the guidance vehicle. Since the transport vehicle 10 travels autonomously, a driver who drives the transport vehicle 10 is not required. Thus, for example, it is possible to reduce the number of people (drivers) in transportation, and thus the efficiency of transporting the freight W may be further improved.

The guidance vehicle determination unit 14 determines one or a plurality of transport vehicles 10 as the guidance vehicle, based on the required number determined by the number determination unit 12 and a predetermined guidable number. In this case, in the operation management system 1, it is possible to determine one or a plurality of transport vehicles 10 as the guidance vehicle in consideration of the guidable number of vehicles.

The guidance vehicle determination unit 14 may determine the bus 30 as the guidance vehicle, based on the operation plan of the bus 30. In this case, in the operation management system 1, it is possible to determine the bus 30 as the guidance vehicle in consideration of the operation plan of the bus 30. That is, it is possible to also utilize the bus 30 as the guidance vehicle. Accordingly, efficiency of transportation of the freight W may be further improved without a need to prepare a vehicle dedicated for guidance, as the guidance vehicle.

Since the bus 30 is utilized as the guidance vehicle, it is possible to simultaneously transport occupants and freights by the bus 30 as the guidance vehicle and the transport vehicles 10 that transport the freights W. Thus, the efficiency of the entire physical distribution may be improved.

For example, in a case where the bus 30 serves as the guidance vehicle and guides the transport vehicle 10, the efficiency of transporting occupants by the bus 30 may be decrease, for example, the bus 30 takes extra time to reach the destination B2 with stopping at the first cross dock A1, the second cross dock A2, and the like. In such a case, convenience may be provided to occupants of the bus 30, for example, the fare of the bus 30 may be discounted. Thus, it is easy to ask for understanding of occupants for using the bus 30 as the guidance vehicle, and it is possible to increase a realizability of simultaneously transporting occupants and freights.

Hitherto, the embodiment of the present disclosure has been described above, but the present disclosure is not limited to the above embodiment. For example, the transport vehicle 10 travels following the guidance vehicle with a predetermined vehicle-to-vehicle distance when guided by the guidance vehicle, but the transport vehicle may be guided by another method. For example, the transport vehicle 10 may be connected to the guidance vehicle and travel by being towed by the guidance vehicle.

Although the regular operation vehicle is set to the bus 30, a vehicle other than the bus 30 may be used as long as the vehicle operates regularly. The transport vehicle 10 is not limited to an autonomous driving vehicle. For example, the transport vehicle 10 may be a vehicle capable of partially supporting a driving operation of a driver (for example, vehicle-to-vehicle distance). In this case, when guided by the guidance vehicle, the transport vehicle 10 may travel following the guidance vehicle by supporting a part of the driving operation of the driver. The transport vehicle 10 may be a manually driving vehicle which travels by a driving operation of a driver.

In the above-described embodiment, the bus 30 is utilized as the guidance vehicle in a case where the bus 30 may serve as the guidance vehicle, based on the operation plan of the bus 30. The present disclosure is not limited thereto, and the operation management system 1 may have a configuration of using the bus 30 as the guidance vehicle in principle. That is, for example, the operation plan (departure time) of the transport vehicle 10 which transports the freight W from the first cross dock A1 to the second cross dock A2 may be predetermined such that the bus 30 can be used as the guidance vehicle.

The transport vehicle 10 may not have a configuration of departing from the first cross dock A1 in accordance with the departure time of the predetermined operation plan. For example, the transport vehicle 10 may have a configuration of departing from the first cross dock A1 in a case where the freight W to be transported to the second cross dock A2 has gathered in the first cross dock A1 in a predetermined amount or more. In this case, in the operation management system 1, the required number of transport vehicles 10 used for transportation may be determined based on the shape, the weight, and the like of the freight W.

Although the transport vehicle 10 transports the freight W between the cross docks A, the present disclosure is not limited to the cross dock A. The transport vehicle 10 may transport the freight W between facilities other than the cross dock A.

What is claimed is:

1. An operation management system that manages an operation of a transport vehicle that transports a freight from a first location to a second location, the system comprising:
a freight information acquisition unit that acquires freight information including a delivery destination of the freight for each freight;
a number determination unit that determines a required number of transport vehicles for transporting the freight from the first location to the second location, based on the freight information acquired by the freight information acquisition unit; and
an output unit that outputs information regarding the required number determined by the number determination unit.

2. The operation management system according to claim 1,
wherein the transport vehicle departs from the first location at each departure time defined in a preset operation plan of the transport vehicle, and
the number determination unit determines the required number for each departure time, based on the freight information.

3. The operation management system according to claim 1,
wherein the transport vehicle transports the freight by being guided or towed by a guidance vehicle in at least one of sections from the first location to the second location.

4. The operation management system according to claim 3, further comprising:
a guidance vehicle determination unit that determines the guidance vehicle,
wherein the guidance vehicle determination unit determines one or a plurality of transport vehicles as the guidance vehicle, based on the required number determined by the number determination unit and a predetermined guidable number of vehicles allowed to be guided by the guidance vehicle, and
the output unit further outputs information of the transport vehicle determined as the guidance vehicle.

5. The operation management system according to claim 3, further comprising:
a guidance vehicle determination unit that determines the guidance vehicle; and
an operation plan acquisition unit that acquires an operation plan of a regular operation vehicle,
wherein the guidance vehicle determination unit determines any one or more of the transport vehicle and the regular operation vehicle as the guidance vehicle, based on the required number determined by the number determination unit, a predetermined guidable number of vehicles allowed to be guided by the guidance vehicle, and the operation plan of the regular operation vehicle, and
the output unit outputs information of at least any one of the transport vehicle and the regular operation vehicle determined as the guidance vehicle.

6. The operation management system according to claim 5,
wherein the regular operation vehicle is a bus capable of transporting a plurality of occupants.

7. The operation management system according to claim 3,
wherein the guidance vehicle is a bus capable of transporting a plurality of occupants.

8. The operation management system according to claim 3,
wherein the transport vehicle is an autonomous driving vehicle capable of traveling autonomously, and autonomously travels following the guidance vehicle, by being guided by the guidance vehicle.
